(19) United States
(12) Patent Application Publication
(10) Pub. No.: US 2014/0101875 A1
(43) Pub. Date: Apr. 17, 2014

(54) DISC GOLF DISC WASHER

(71) Applicant: Jordan Fengel, Temple, TX (US)

(72) Inventor: Jordan Fengel, Temple, TX (US)

(21) Appl. No.: 14/054,164

(22) Filed: Oct. 15, 2013

Related U.S. Application Data
(60) Provisional application No. 61/713,694, filed on Oct. 15, 2012.

(51) Int. Cl. B08B 3/04; B08B 1/00

(52) U.S. Cl. CPC B08B 3/04; B08B 1/001
USPC 15/104.92

(57) ABSTRACT

A disc golf disc washer including a washer assembly having a reservoir configured to contain and liquid, and a washing region in fluid communication with the reservoir, the washing region having an opening sized for acceptance of a recreational throwing disc.

### CROSS-REFERENCE

The present application claims priority from U.S. Provisional Patent Application No. 61/713,694, filed Oct. 15, 2012, entitled “DISC GOLF DISC WASHER”, naming inventor Jordan Fengel, which application is incorporated by reference herein in its entirety.

### BACKGROUND

1. Field of the Disclosure

The following is directed to a washer, and particularly a disc golf disc washer.

2. Description of the Related Art

Disc golf is a disc game in which individual players throw a flying disc at a target, with the purpose of accumulating the fewest number of throws of the disc from a tee to the target. Generally, the basic components of a disc golf course include a tee pad and a target, which may be referred to more commonly as a basket. A tee pad provides a firm and level foundation to start play from or “tee off”. Some courses have alternative tee pads for a given hole. Similar to traditional golf, one or more tees may be closer to the target, allowing multiple players of different skill levels a better chance of competitive play.

The target or basket is generally formed from a center pole, chain holder and a basket. A set of chains hang down from the chain holder surrounding the center pole and serve to catch a thrown disc. When the disc drops into the basket the hole is completed and the player moves to the next hole, which is designated with another tee pad.

Also, analogous to the various types of clubs in traditional golf, there different types of discs in disc golf that are used in different playing situations. The basic types of discs include putters, mid-range discs, and drivers. Putters are designed to fly straight, predictably, and very slowly compared to mid-range discs and drivers. Mid-range discs have slightly sharper edges, which enable them to cut through the air better. Drivers generally have the sharpest edges and have most of their mass concentrated on the outer rim of the disc rather than distributed equally throughout.

Players, especially experienced players, may carry a dozen or more discs with them, together with accessories such as disc bags, water or other beverage, sunscreen, towels, jacket, umbrella, folding chair and so forth. Discs are typically carried in a duffel bag or something similar and carriers specifically adapted for carrying disks and some accessories are commercially available.

The popularity of disc golf has grown dramatically over the last several years, and there continues to be a need for improved devices for improved play and greater enjoyment at all levels.

### SUMMARY

According to a first aspect, a disc golf disc washer include a washer assembly having a reservoir configured to contain and liquid, a washing region in fluid communication with the reservoir, the washing region having an opening sized for acceptance of a recreational throwing disc, wherein the washer assembly comprises a drain extending to the ground.

According to a second aspect, a portable disc golf disc washer includes a portable washer housing assembly having a first portion comprising a first scrubbing member, a second portion coupled to the first portion and comprising a second scrubbing member, wherein the first portion and second portion define a wash chamber, and a reservoir contained within an interior of at least one of the first portion or the second portion.

In yet another aspect, a portable disc golf disc washer includes a portable washer housing assembly including a first portion, a second portion coupled to the first portion, wherein the first portion and second portion define a wash chamber, and wherein the first portion comprises a first opening in a first inner surface, the first opening in fluid communication with the wash chamber.

### BRIEF DESCRIPTION OF THE DRAWINGS

The present disclosure may be better understood, and its numerous features and advantages made apparent to those skilled in the art by referencing the accompanying drawings.

FIG. 1 includes a front view of a disc golf disc washer according to an embodiment.

FIG. 2 includes a front view of a disc golf disc washer according to an embodiment.

FIG. 3 includes a cross-sectional view of a portion of a disc golf disc washer according to an embodiment.

FIG. 4 includes a side view of a disc golf disc washer according to an embodiment.

FIG. 5 includes a top view of a disc golf disc washer according to an embodiment.

FIG. 6 includes a perspective view of a portable disc golf disc washer in an open position according to an embodiment.

FIG. 7 includes a perspective view of a portable disc golf disc washer in a closed position according to an embodiment.

FIG. 8 includes an illustration of a reservoir in accordance with an embodiment.

FIG. 9 includes an illustration of a portion of the reservoir integrally formed with a first portion of a portable washer housing assembly according to an embodiment.

The use of the same reference symbols in different drawings indicates similar or identical items.

### DETAILED DESCRIPTION

The following is directed to a disc golf disc washer, configured to be used on a disc golf course. The embodiments herein include various features of different washers, including a washer assembly that can be fixed in one position, such as at a set location on a disc golf course. Other embodiments, disclose use of a portable disc golf disc washer that may be carried by a person on the course.

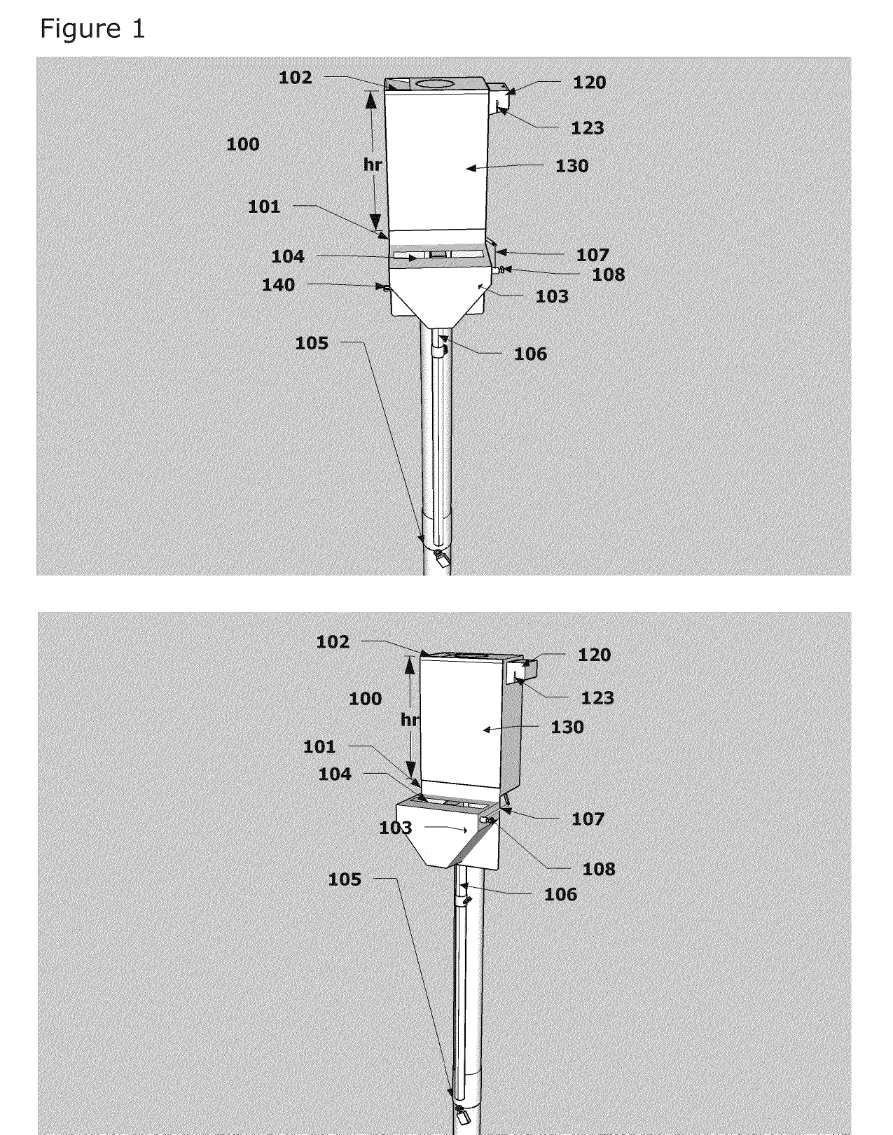

Referring to FIG. 1, a disc golf disc washer is illustrated including a washer assembly 100, a reservoir 101 configured to contain a liquid 102, and a washing region 103 in fluid communication with the reservoir 101. Notably, the washing region 103 has an opening 104 sized for acceptance of a recreational throwing disc.

According to one embodiment, the washer assembly 100 can be mounted to the ground 105. In particular instances, the washer assembly 100 can include a drain 106 extending near the ground 105. In one certain design, the drain 106 can extend to the ground 105, and more particularly, the drain 106 can extend into the ground and may even extend to a capture reservoir under the ground and intended for recycling of water.

In one aspect, the drain 106 may extend between the reservoir 101 and the upper surface of the ground 105. In an alternative design, the drain 106 extends between the washing region 103 and the ground 105. The drain 106 may also include one or more valves to control the flow of fluid therethrough.

The disc golf disc washer may include a dispenser 107 connected to the reservoir 101, wherein the dispenser 107 can be configured to control fluid flow from the reservoir 101 to the washing region 103. The dispenser 107 may also be configured to control a fluid level within the reservoir 101, and particularly, the dispenser 107 may be configured to automatically control the fluid level without user input. For example, in one instance, the dispenser 107 can automatically control the fluid level via gravity flow self-regulation. Alternatively, the dispenser 107 can be user operated. In certain designs, the dispenser 107 can include a valve 108. The dispenser may also include other features, including for example, a screen, which may facilitate control of particles from entering the washing region 103.

According to one embodiment, the dispenser 107 may include selectable outputs. For example, the dispenser 107 may be formed to have a first output and a second output, wherein the first output and second output dispensing fluid to different points. For example, the first output can deliver fluid to the washing region 103 and the second output can deliver fluid to a drain. The dispenser 107 may be movable between a first position and a second position. The dispenser 107 can be articulating between the first position and the second position, which may also correspond to the first output and the second output. However, it will be appreciated that in certain designs, the dispenser 107 need not be articulating to have multiple outputs.

The dispenser 107 may be designed to have a selector configured to provide a plurality of settings for delivery of water velocity and position of the dispenser relative to other portions of the washer (e.g., reservoir 101, washing region 103, etc.). The dispenser 107 can be in fluid communication with a bottom surface of the reservoir 101, and may be coupled directly to the bottom surface of the reservoir 101. Alternatively, the dispenser 107 may be in fluid communication with a side surface of the reservoir 101. The dispenser 107 can include a tube, which may be coupled to a surface of the washing region 103.

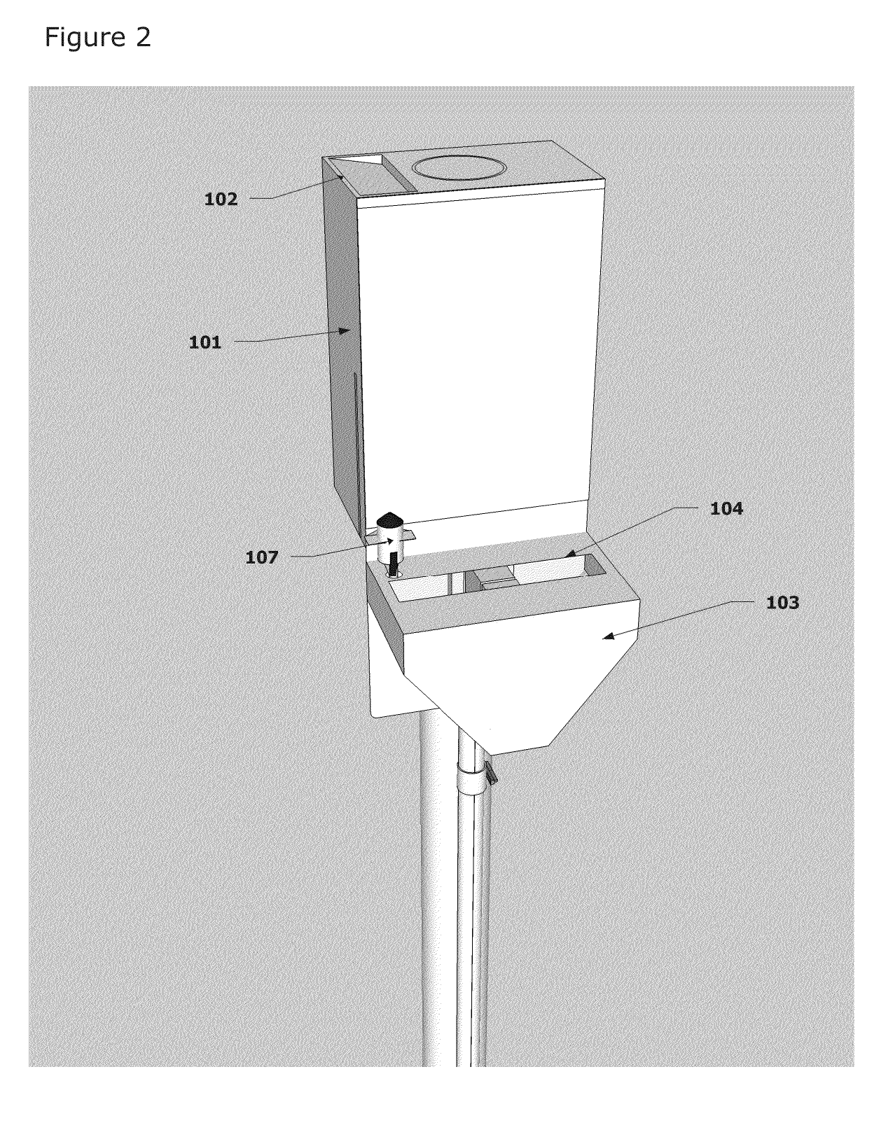

While FIG. 1 illustrates a dispenser 107 connected at a side surface of the washer assembly 100, alternative designs are contemplated. For example, FIG. 2 includes a front view of an washer assembly according to an embodiment, wherein the dispenser 107 is connected to a front surface of the reservoir 101 and configured to dispense the fluid 102 into the washing region 103 through the opening 104.

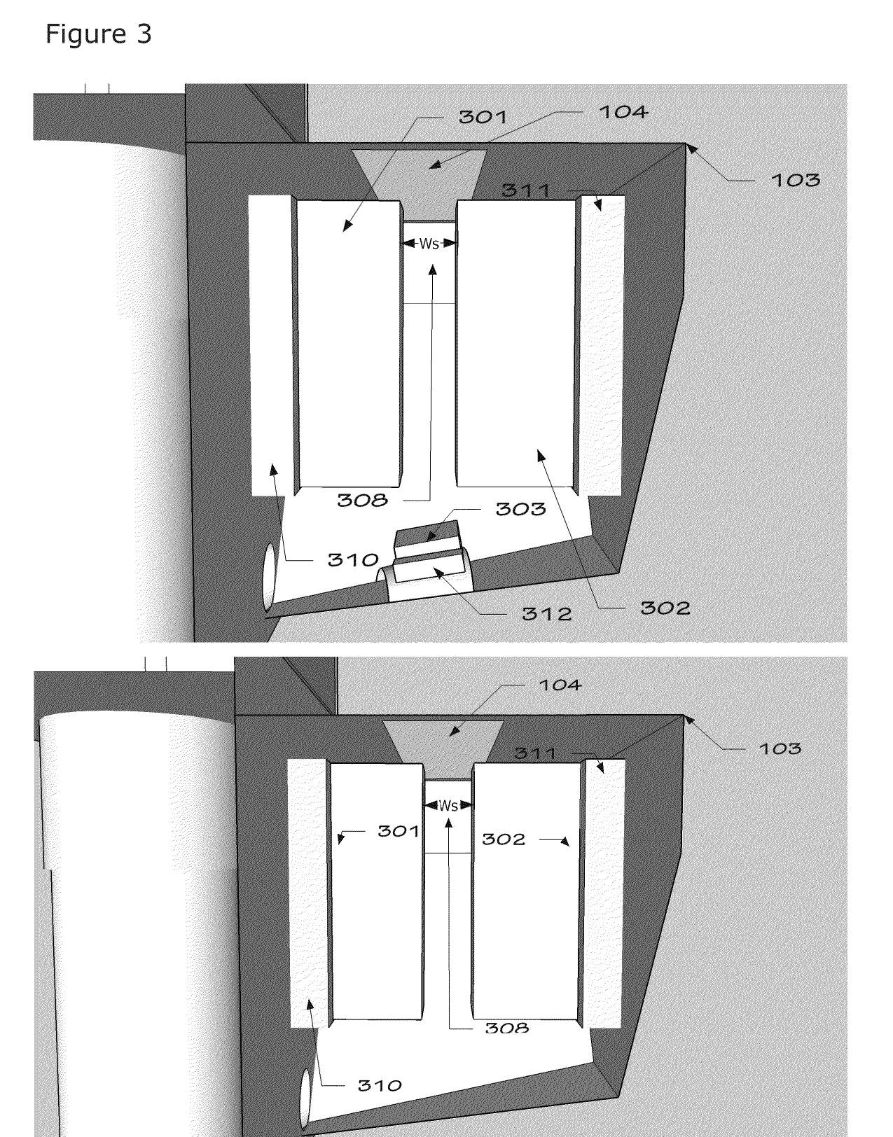

As illustrated in FIG. 3, the washing region 103 of the disc golf disc washer can include at least one scrubbing member, such as a first scrubbing member 301. In other instances, the washing region 103 can include a plurality of scrubbing members. In one design, the washing region can include a first scrubbing member 301 and a second scrubbing member 302. In particular instances, the first and second scrubbing members 301 and 302 can be oriented relative to each other to form a slot 308 between the two exterior surfaces of the scrubbing members 301 and 302 having a predetermined size relative to a width of a recreational throwing disc. For example, the slot 108 can have a cross-sectional width (Ws) less than a width of the recreational throwing disc. The slot 108 can be accessible from the opening 104 in the washing region 103.

In particular instances, the at least one scrubbing member, such as the first and second scrubbing members 301 and 302, can be disposed adjacent to the opening 104 and configured to engage the recreational throwing disc upon entry to the washing region 103. The washing region 103 may also include a third scrubbing member 303 different than the first and second scrubbing members 301 and 302. The third scrubbing member 303 can be spaced apart from the first scrubbing member 301 and the second scrubbing member 302. In certain designs, the third scrubbing member 303 can define a plane that is placed at an angled relative to a plane defined by the first scrubbing member 301. Moreover, the third scrubbing member 303 can define a plane that is placed at an angle relative to a plane defined by the second scrubbing member 302. In particular designs, any one of the foregoing angles may be perpendicular, obtuse, or acute.

The washing region 103 can include a first scrubbing member 301 coupled to a holder 310. The first scrubbing member 301 can be removably coupled to the holder 310. In particular instances, the holder 310 can be fixedly attached to a body of the washing region 103, such as an interior wall of the washing region 103. According to certain other designs, the first scrubbing member 301 can be slideably attached to the holder 310, such that translation of the first scrubbing member 301 in a plane may attach and release the first scrubbing member 301 from the holder 310. The first scrubbing member 301 can be configured to be removed from the holder 310 after worn.

The washing region 103 may contain a first scrubbing member that can be removably coupled to a first holder 310. More particularly, the first scrubbing member 301 can be configured for articulation between a first position and a second position, which may facilitate removal of the first scrubbing member 301 or a change of position for improved cleaning of the disc during use of the disc golf disc washer.

Additionally, in certain instances, the second scrubbing member 302 can be removably coupled to a second holder 311. The second scrubbing member 302 and the second holder 311 can have any of the features described herein. Moreover, for some designs, a third scrubbing member 303 can be removably coupled to a third holder 312. The third holder 312 and third scrubbing member 303 can have any of the features described herein. In one particular embodiment, at least one of the scrubbing members in the washing region 103 may be articulated while another scrubbing member is stationary. Such an arrangement may facilitate improved cleaning of a disc during use.

In certain embodiments, the washing region 103 can include a first scrubbing member 301 and a second scrubbing member 302, wherein the first scrubbing member 301 can have a different contour than the second scrubbing member 302. That is the first scrubbing member 301 can have a first shape that is different than the shape of the second scrubbing member 302 when viewed in three-dimensions, in cross-section through a longitudinal axis, or in cross-sectional through a lateral axis. The difference in shape between the first scrubbing member 301 and the second scrubbing member 302 may be utilized to facilitate improved washing of one region of the disc relative to the position of the scrubbing member. For example, the first scrubbing member 301 may be formed with a lip or protrusion to facilitate cleaning of a unique surface of a disc, including for example, a recessed surface on the underside of the disc. It will be appreciated that the third scrubbing member 303 may have a shape that is different than the first scrubbing member 301, second scrubbing member 302, and a combination thereof.

Furthermore, in certain designs, the first scrubbing member 301 may have a different scrubbing characteristic than the second scrubbing member 302. Different scrubbing characteristics may be facilitated by bristle count, bristle type, bristle arrangement, bristle length, composition, fiber arrangement, abrasive material type, and a combination thereof. A difference in the scrubbing characteristics of the first scrubbing member 301 relative to the second scrubbing member 302 may facilitate improved cleaning of different types of surfaces on the disc. For example, the first scrubbing member 301 may have a greater abrasive nature as compared to the second scrubbing member 302, since the first scrubbing member 301 may be positioned in the washing region in a predetermined manner to engage a particular surface of the disc more likely to have a greater content of debris as compared to the second scrubbing member 302. As such, in certain embodiments, the washing region 103 may have a particular arrangement and tailoring of the scrubbing characteristics of the scrubbing members to facilitate improved cleaning capabilities and improved lifetime of the scrubbing members.

The first scrubbing member 301 can include a sponge, a composite sponge having a first portion of high density and a second portion having less density (i.e., greater porosity as compared to the first portion, an abrasive material, steel wool, bristles, and a combination thereof. The second scrubbing member 302 and third scrubbing member 302 can include any one of the same features as the first scrubbing member 301.

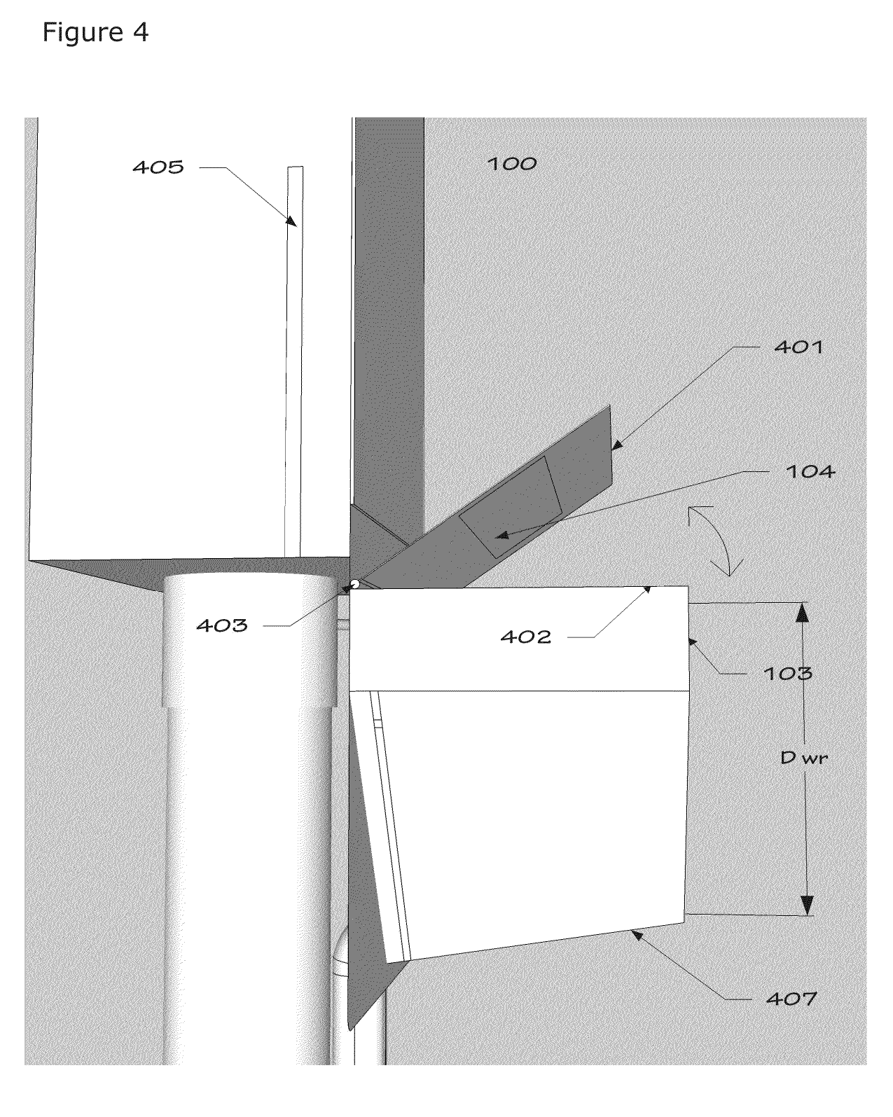

The washing region 103 may include a cover 401, as illustrated in an embodiment of FIG. 4, which can be positioned to overly the opening 104 to the washing region 103. The cover 401 can be removable from a body of the washing region 103. Moreover, the cover 401 may be movable between a first position and a second position, for example, facilitating selective opening and closing of the cover 401 for access to the washing region 103. FIG. 4 demonstrates one type of movement of the cover 401 relative to an upper surface of the washing region 103 and the opening 104 to facilitate opening and closing of access to the opening 104 by a user. In some instances, the cover 401 can be removable and configured to detach from a body of the washing region 103. It will be appreciated, that in certain embodiments, the cover 401 can include a moving member facilitating movement of the cover 401 in one or more directions. Some suitable examples of moving members include mechanism such as hinges, clips, slides, slots, latches, springs, and a combination thereof. FIG. 4 demonstrates a cover 401 attached to an upper surface 402 of the washing region 103 by a hinge 403, allowing articulation of the cover 401 in the direction demonstrated by the arrows.

In a particular embodiment, the cover 401 may include an opening configured to facilitate fluid flow from the dispenser 107. More particularly, the cover 401 can include a dispenser opening, wherein the cover 401 comprise an opening facilitating fluid communication with the dispenser 107 and the washing region 103.

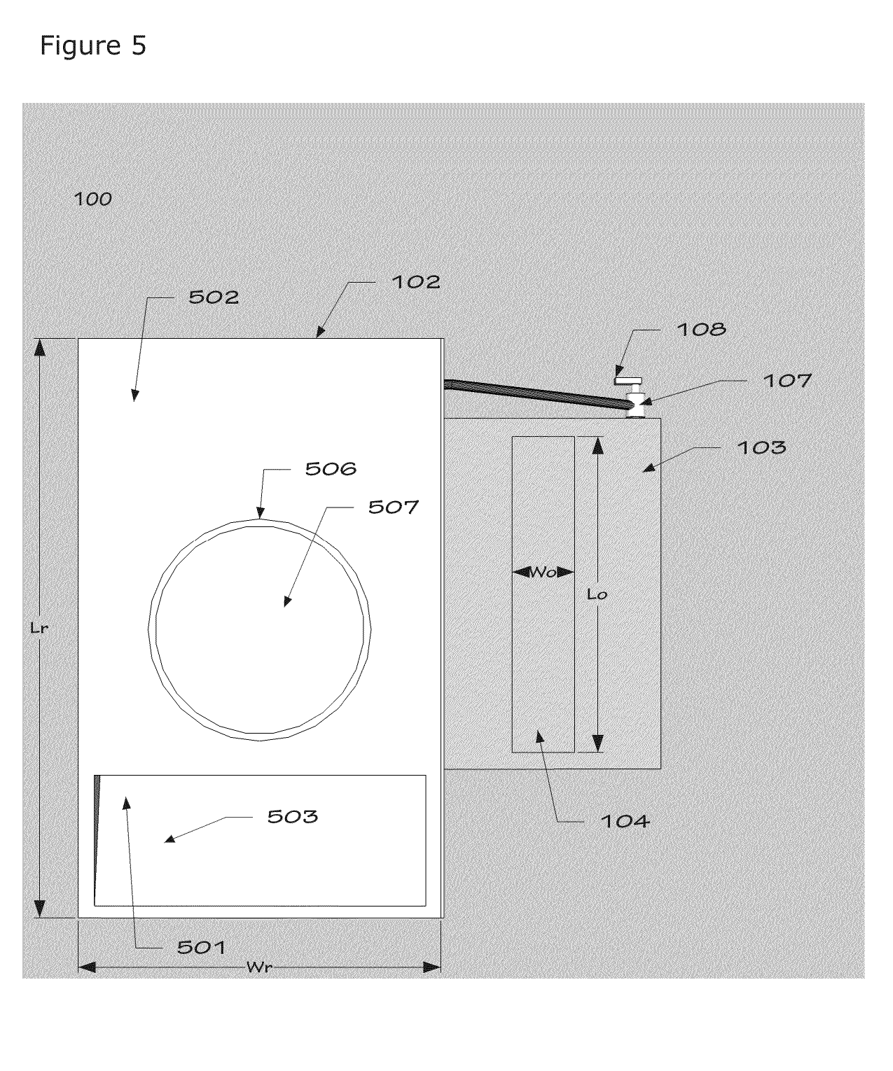

The reservoir 101 can include a fill access 501 allowing provision of fluid from an outside source into the reservoir 101, as illustrated in FIG. 5 including a top view of a washer assembly according to an embodiment. In particular instances, the fill access 501 may include an opening 503. In still other embodiments, the fill access 501 may include a valve, allowing selective entry of fluid into the reservoir 101. The fill access 501 may be positioned within an upper region of the reservoir 101, and more particularly, can be disposed in an upper surface 502 of the reservoir 101. For certain designs, the fill access 501 can have a cover, which may be moveable between an open position and a closed position. The cover may be connected to the reservoir 101 by a hinge or other suitable connection mechanism. In certain instances, the fill access 501 may include a screen, which may be in the form of a mesh overlay material, suitable for reducing particulate material in the reservoir 101 and washing region 103.

In accordance with at least one aspect, the reservoir 101 can have a capacity, as measured by a volume (e.g., lr×wr×hr) of at least about 0.5 gallons, which may be tailored to use of disc golf discs. In other embodiments, the capacity of the reservoir 101 can be greater, such as at least about 0.7 gallons, at least about 0.9 gallons, at least about 1 gallon, or even at least about 1.2 gallons. Still, the capacity of the reservoir 101 may be not greater than about 3 gallons, not greater than about 2.8 gallons, not greater than about 2.5 gallons, or even not greater than about 2.2 gallons. The capacity of the reservoir 101 can be within a range between any of the minimum and maximum values noted above.

Another feature of the reservoir 101 includes an internal sleeve 506. The internal sleeve 506 can be configured to couple to a pole 507 designed to hold the washer assembly 100 at a desired location. The pole 507 can be coupled to the ground and the reservoir 101 via in the internal sleeve 506. For certain designs, the internal sleeve 506 may extend for a portion of the height (hr) of the reservoir 101. Alternatively, the internal sleeve 506 may extend for a majority of the height (hr) of the reservoir 101, and more particularly, may extends for essentially the entire height of the reservoir 101. In other instances, the internal sleeve 506 may extend for a length beyond the height (hr) of the reservoir 101, extending external to the reservoir 101 and above the height of the reservoir 101 and washer.

For certain washer assembly designs, the reservoir 101 can include a secondary basin 120. In at least one embodiment, a portion of the secondary basin 120 can extend externally to the volume of the reservoir 101, such that at least a portion of the secondary basin 120 may be coupled directly to an exterior side surface 121 of the reservoir 101. The secondary basin can be in fluid communication with the interior volume of the reservoir 101. The secondary basin 120 and the reservoir 101 can be coupled by a port, which may include a flow control device, such as a valve to control the flow of fluids between the secondary basin 120 and the reservoir 101.

In yet another embodiment, the reservoir 101 can include a secondary basin 120 that can be housed internally within the volume of the reservoir 101. For example, the secondary basin 120 may be contained entirely within the interior volume of the reservoir 101. The secondary basin 120 may be accessible to a user. The secondary basin can be in fluid communication with the interior volume of the reservoir 101. The secondary basin 120 and the reservoir 101 can be coupled by a port, which may include a flow control device, such as a valve to control the flow of fluids between the secondary basin 120 and the reservoir 101.

The secondary basin 120 may be configured to contain an additive 123. The additive 123 can include a material, such as a liquid or solid material (e.g., capsule), that may include an organic material, inorganic material, and a combination thereof. In particular instances, the additive 123 may be suitable for increasing the cleaning abilities of the washer, a solvent. For example, the additive 123 may include a composition such as a surfactant, a solvent, soap, a salt, an alcohol, an antibacterial, an antimicrobial, and a combination thereof. The additive 123 may be selectable by a user, such that it may be added to the reservoir 101, washing region 103, or directly to an article of the user (e.g., a disc golf disc) to enhance the capabilities of the washer.

The washer assembly 100 may include a material selected from the group of materials consisting of metals, ceramics, plastics, composites, and a combination thereof. In one specific embodiment, the washer assembly 100 can include a plastic material, and more particularly, may be made essentially of a plastic material. Some suitable materials may also include biodegradable materials, recyclable material, and materials that are environmentally friendly and reduce the impact on the waste cycle.

Certain designs of the washer assembly 100 may include a reservoir 101 having a transparent region, wherein transparency is measured as a transmittance of at least 70% of the light over the visible spectrum. The transparent region may be a fraction of the total surface area of the reservoir 101. More particularly, the transparent region may be associated with a fluid fill level indicator 405, allowing a user to determine the amount of fluid contained within the reservoir 101. In other embodiments, the transparent region can include substantially all of the total surface area of the reservoir 101, such that the entirety of the walls defining the reservoir 101 is transparent.

In certain instances, a least a portion of the washer assembly 100, and more particularly, the entire washer assembly 100 can be made of a transparent material having a transparency of at least about 50% across the spectrum of visible radiation (wavelengths between about 350 nm to about 800 nm). In another embodiment, the washer assembly 100 can have a transparency of at least about 60%, such as at least about 70%, at least about 80%, at least about 90%, or even at least about 95% across the spectrum of visible radiation. According to one embodiment, the washer assembly 100 can be made of an organic material, such as a polymer, and more particularly, a material such as poly(methyl methacrylate) (PMMA), polyvinylidene fluoride (PVDF), polypropylene (PP), or polyetheretherketone (PEEK), and a combination thereof. In certain designs, the washer assembly 100 can be made essentially of a material such as poly(methyl methacrylate) (PMMA), polyvinylidene fluoride (PVDF), polypropylene (PP), or polyetheretherketone (PEEK),

For at least one aspect, the washing region 103 can have an opening 104 configured to have a dimension suitable for acceptance of a disc therein. For example, in one embodiment, the opening 104 can be defined by an aspect ratio of length:width, wherein the length (l₀) is the longest dimension of the opening 104 and the width (w₀) is a dimension extending perpendicular to the length and defining a shorter dimension relative to the length (l₀). In at least one instance, the opening 104 can have an aspect ratio of at least about 2:1, such as at least about 3:1, or even at least about 4:1.

According to one design, the opening 104 can have a length (l₀) of at least about 10 cm, such as at least about 12 cm, or even at least about 15 cm. Still, in one non-limiting embodiment, the opening 104 can have a length of not greater than about 50 cm, not greater than about 35 cm, or even not greater than about 25 cm. It will be appreciated that the length of the opening 104 can be within a range between any of the minimum and maximum values noted above.

Moreover, the width (w₀) of the opening 104 can be at least about 0.5 cm, such as at least about 0.8 cm, at least about 1 cm, or even at least about 1.5 cm. Still, in one non-limiting embodiment, the opening 104 can have a width of not greater than about 10 cm, such as not greater than about 8 cm, or even not greater than about 6 cm. It will be appreciated that the width of the opening 104 can be within a range between any of the minimum and maximum values noted above.

In certain designs, the washing region 103 can have a second aspect ratio defined by the opening length (l₀) to a depth (d_{wr}) of the washing region, wherein the depth extends between the upper surface 402 of the washing region comprising the opening vertically downward to a bottom surface 407 of the washing region 103. According to one embodiment, the second aspect ratio (l₀/d_{wr}) can be at least about 0.5, such as at least about 0.8, at least about 0.9, or even at least about 1.0. In one non-limiting embodiment, the second aspect ratio can be within a range between about 0.5 and about 1.5, or even between about 0.8 and about 1.2.

The washing region 103 can have a depth (d_{wr}) designed to accommodate at least a portion of a recreational disc. For example, the washing region 103 can have a depth of at least about 2 cm, such as about 3 cm, or even at least about 4 cm. Still, for certain embodiments, the washing region may have a depth of not greater than about 15 cm, such as not greater than about 10 cm, or even not greater than about 8 cm. It will be appreciated that the depth of the washing region 103 can be within a range between any of the minimum and maximum values noted above.

The washer assembly 100 can be designed such that it includes placard region 130. The placard region 130 may be disposed on a surface of the washer assembly 100, and more particularly a portion of the reservoir 101 exterior surface, in a readily viewable region, such that any information placed on the placard region 130 (e.g., advertisements, method of using the washer, environmental reminders, sponsorship information) can be readily viewable to the public or a user of the washer. According to one embodiment, the placard region 130 can be disposed on a surface of the washing region 103.

The disc golf disc washer may further include a fastener mechanism 140 coupled to a portion of the washer assembly 100. The fastener mechanism 140 can be configured to hold a tool suitable for cleaning of a recreational disc, including for example, a towel, a brush, a scrubbing member, a blade, a pick, an abrasive article, and a combination thereof. The fastener mechanism 140 may be a mechanism selected from the group consisting of a clip, a slide, a latch, a screw, a nail, a bolt, and a combination thereof. The fastener mechanism 140 may be coupled to an exterior surface of the washer assembly 100 in a position readily available for a user.

While it will be appreciated that the disc golf disc washer of the embodiments herein can be affixed to the ground in a single location, the washer assembly 100 can be portable. As such, it may be moved from one location to another location as needed on a disc golf course.

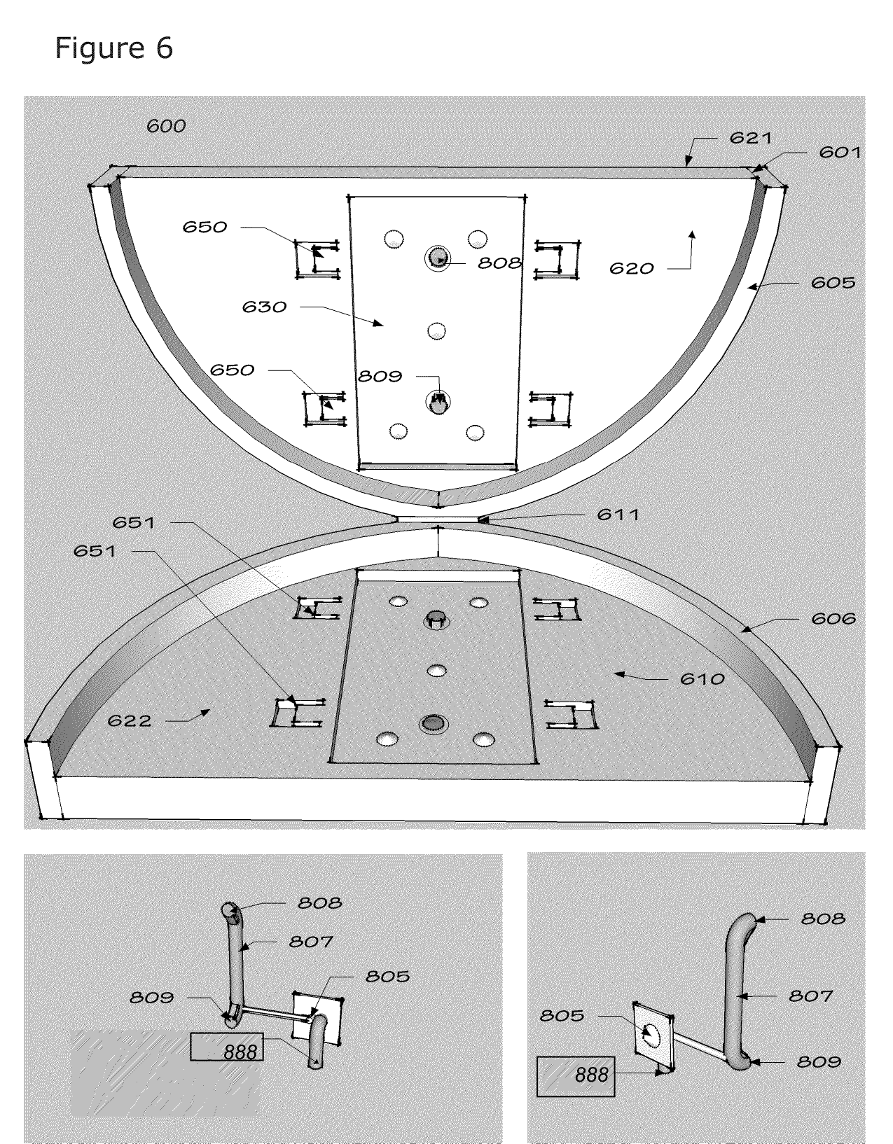

Turning to FIGS. 6-9, an alternative design of a washer assembly is provided. Notably, the washer design of FIGS. 6-9 is configured to have improved portability and may be configured for regular wear and use by a player. For example, the portable disc golf disc washer can be easily carried on a person for an entire round and is not necessarily affixed to one location on the disc golf course.

In one embodiment, the portable disc golf disc washer (i.e., portable washer) can include a portable washer housing assembly 600 including a first portion 601 and a second portion 602 coupled to the first portion 601. Notably, the first portion 601 and second portion 602 can define a wash chamber within the interior space defined by the first portion 601 and the second portion 602 in a closed position.

The portable washer can have a variety of shapes. In one non-limiting design, the first portion 601 can have a hemispherical shape as viewed in cross-section defined by the length and width of the first portion 601. The second portion 602 can have a shape corresponding to the shape of the first portion 601, and more particularly, complementing the shape of the first portion 601. For example, the second portion 602 can have a hemispherical shape as viewed in cross-section of the length and width of the second portion 602.

Moreover, the first portion 601 and the second portion 602 can have complementary shapes, such that they can articulate with respect to each other. For example, the first portion 601 and second portion 602 can articulate from an open position to a closed position. In the open position, certain surfaces of the first portion 601 and second portion 602 can be separated from each other, and provide general access to internal surfaces of the first portion 601 and second portion 602 by a user. See, FIG. 6 for an illustration of the portable washer housing assembly 600 in an open position.

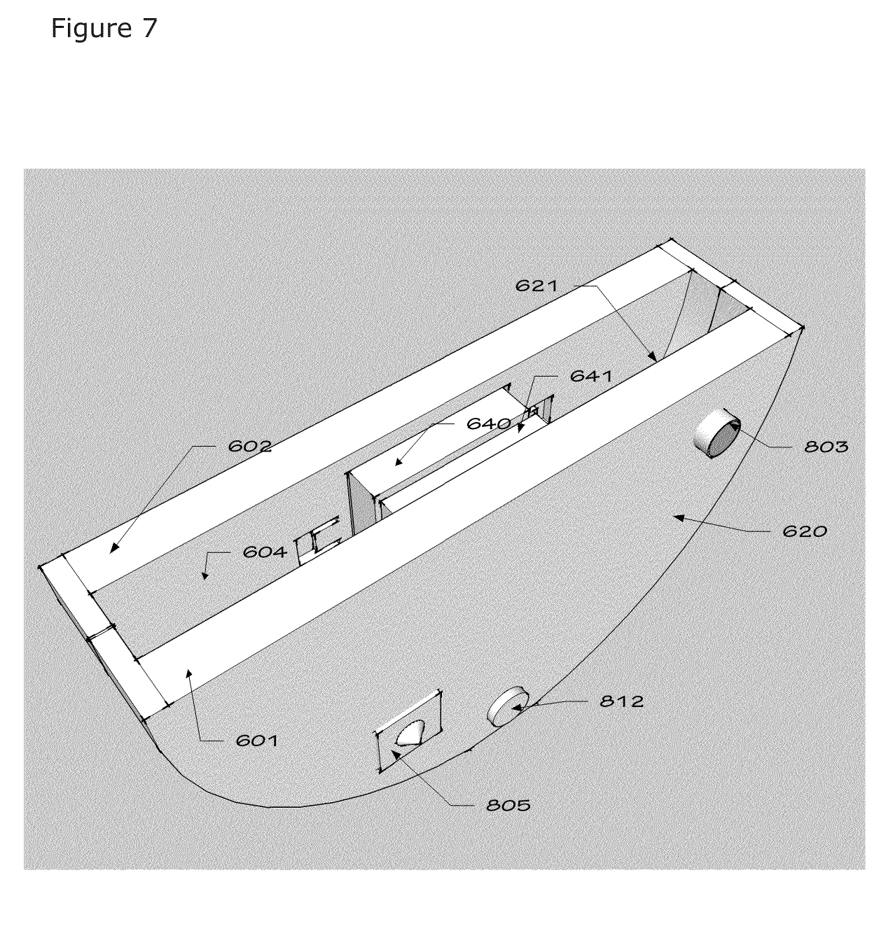

In a closed position, certain surfaces of the first portion 601 and second portion 602, such as peripheral surfaces 605 and 606 can be generally abutting each other. FIG. 7 includes an illustration of the portable washer housing assembly 600 in a closed position. In a closed position, an opening 604 defines access to a wash chamber 610 defined by an interior space between the first portion 601 and second portion 602. The opening 604 can be sized for acceptance and cleaning of a recreational disc. In one particular design, the first portion 601 and second portion 602 can be operably attached by at least one mechanism 611, including but not limited to, a slide mechanism, a hinge, a clip, a latch, a zipper, a fastener, an interference fit connection, and a combination thereof. The mechanism 611 can facilitate movement (e.g., articulation) of the first portion 601 relative to the second portion 602 and changing of positions, such as between an open position and a closed position.

The opening 604 can include any of the features of other openings (e.g., opening 104) described in other embodiments herein.

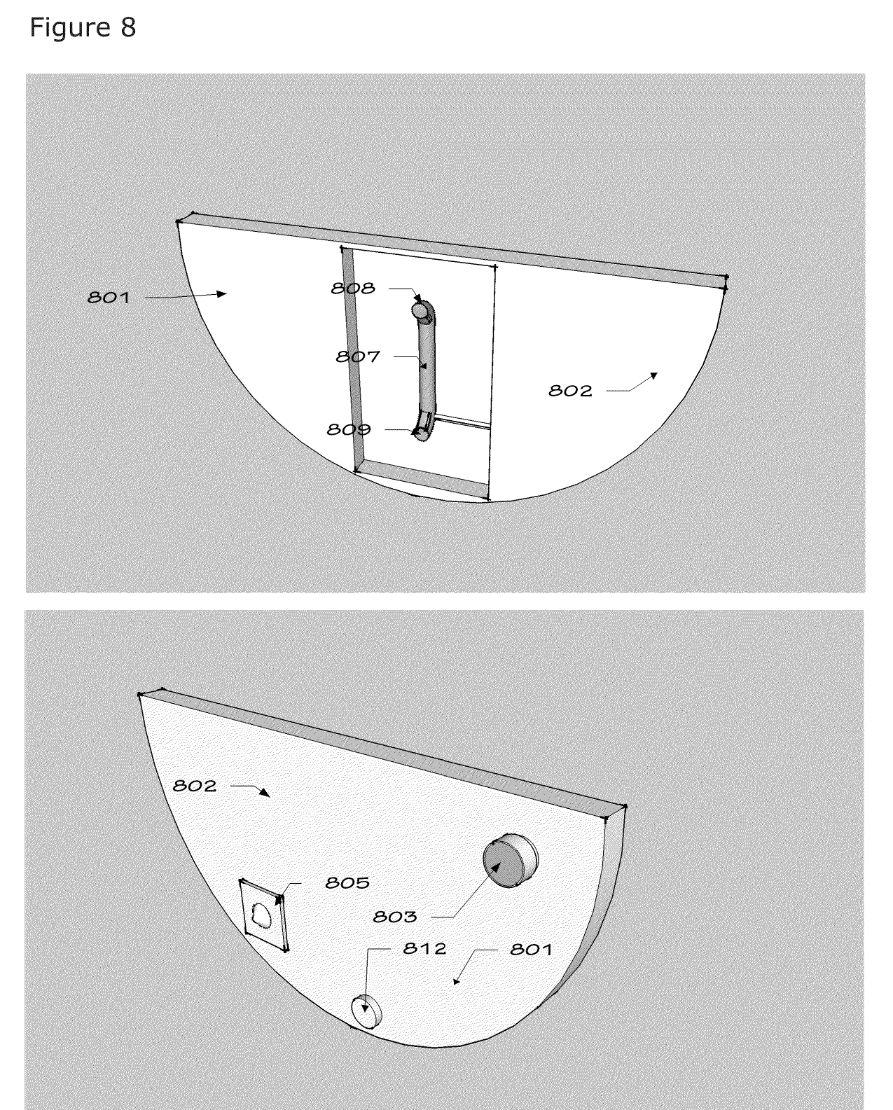

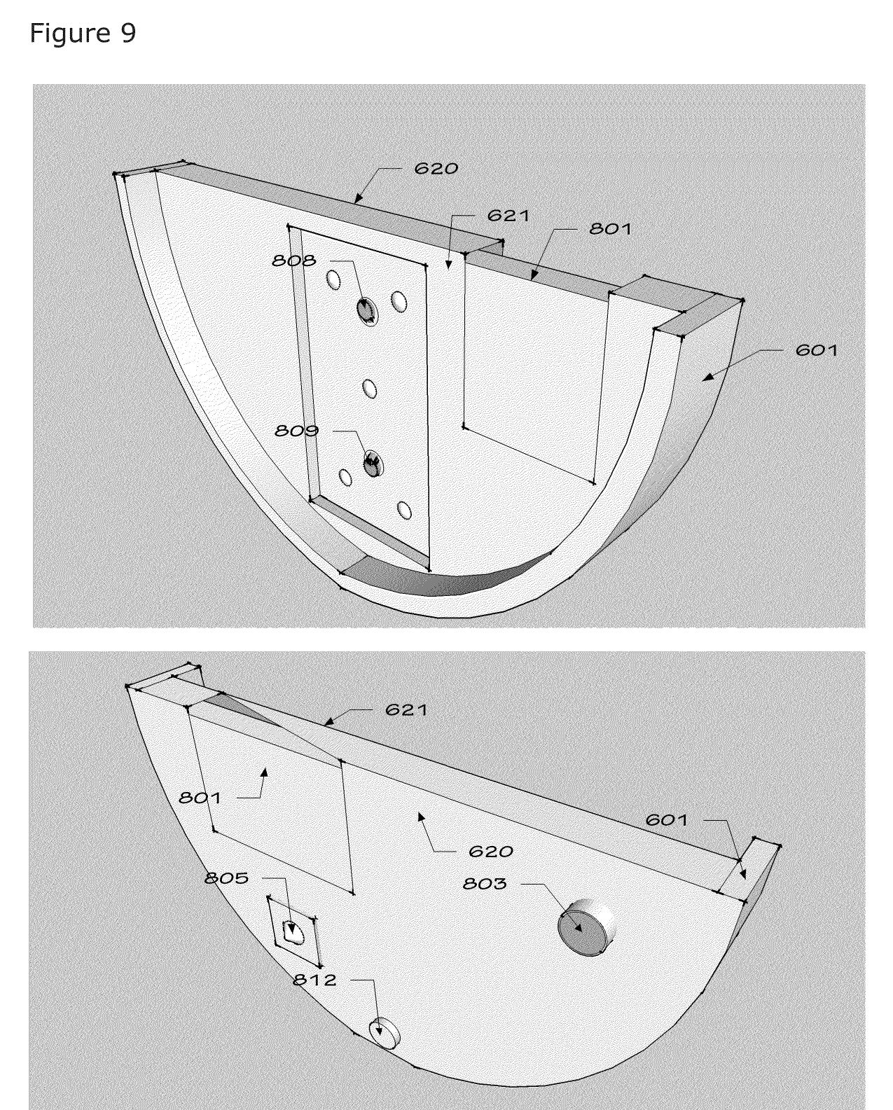

In certain instances, the first portion 601 can include a reservoir 801 configured to contain a liquid suitable for wetting and washing of a recreational disc in the wash chamber 610. FIG. 8 includes an illustration of a reservoir 801 in accordance with an embodiment. FIG. 9 includes an illustration of a portion of the reservoir 801 integrally formed with a first portion of a portable washer housing assembly according to an embodiment. The reservoir 801 can be integral with the body of the first portion 601, and may be at least partially contained within an interior volume of the first portion 601, such as between an exterior wall 620 and interior wall 621 of the first portion 601. Alternatively, in certain instances, the reservoir 101 may be attached to the first portion 601, such as an internal surface of the first portion 601. The reservoir 801 may be removable from the first portion 601, such that it can be cleaned separately from the first portion 601.

For at least one embodiment, the reservoir 801 can include a bladder 802 contained entirely within an interior volume of the first portion 601. The bladder 802 can be made of an organic material. For example, the bladder 802 may include a polymer material, including for example polyethylene terephthalate (PET). According to one particular embodiment, the bladder 802 of the reservoir 101 can be made essentially of PET.

Additionally, the first portion 601 can include a fill port 803. The fill port 803 can be in fluid communication with the reservoir 801 and configured to facilitate filling of the reservoir 801 with a liquid, such as a cleaning fluid configured to be delivered to a disc at least partially contained in the wash chamber 610. In at least one embodiment, the fill port 803 can be at an external surface 620 of the first portion 601 and configured for filling the reservoir 801 without opening the portable washer housing assembly 600, or otherwise articulating the first portion 601 and second portion 602 relative to an open position. Notably, in certain embodiments, the fill port 803 may be in fluid communication with the bladder 802.

The fill port 803 may include a valve, configured to operate between an open position and a closed position. The valve can be user actuated and configured to control the flow of fluid between the fill port 803 and a portion of the reservoir 801, including for example, the bladder 803.

According to one particular embodiment, the first portion 601 can include an exit port 807. The exit port 807 may be fluid communication with at least a portion of the reservoir 801, including for example, in fluid communication with the bladder 802. In one embodiment, the exit port 807 can be at an interior surface 621 of the first portion 601. The exit port 807 can be configured to deliver a liquid of the reservoir 801, and particularly, to the wash chamber 610.

The exit port 807 can have various designs. For example, in the illustrated embodiment, the exit port 807 can include a plurality of openings 808 and 809 to facilitate distribution of the liquid to different portions of the wash chamber 610.

The exit port 807 can be coupled to a first scrubbing member 640 configured to be disposed at an interior surface 621 of the first portion 601. The first scrubbing member 640 can be disposed in a recess 630 in the interior surface 621 of the first potion. The exit port 807, including the plurality of openings 808 and 809 can intersect with the interior surface 621 in the recess and directly contact a surface of the first scrubbing member 640, such that the exit port 807 is configured to deliver the liquid contained in the reservoir 801 to the first scrubbing member 840. Accordingly, the exit port 807 can be in fluid communication with a surface of the first scrubbing member 840.

The exit port 807 may include a valve, configured to operate between an open position and a closed position. The valve can be user actuated and configured to control the flow of fluid between the exit port 807 and the reservoir 101.

Moreover, the first portion 601 can include a drain 812. The drain 812 may be at an exterior surface 620 or peripheral exterior surface of the first portion 601. Alternatively, the drain 812 may be at an interior surface 621 of the first portion 601. The drain 812 can be in fluid communication with the reservoir 801. The drain 812 may include a plug or valve for user operation between an open position and a closed position for control of fluid flow between the reservoir 801 and the drain 812.

The first portion 601 can include an actuator 805, movable between a first position and a second position, and configured to control fluid flow between one portion of the reservoir 801 (e.g., the bladder 802) and at least one port (e.g., the fill port 803, exit port 807, drain 812, etc.). In particular instances, the actuator 805 can control fluid flow of a liquid in the reservoir 101 to the exit port 807 and facilitate delivery of the liquid from the reservoir 801 to a first scrubbing member 840. The actuator 805 may be configured to create a pressure differential between the exit port 807 and a portion of the reservoir 801 (e.g., the bladder 802) to expel a liquid from openings 808 and 809 of the exit port 807. The actuator 805 can be positioned on an external surface 620 of the first portion 601 and configured to be user operated. The actuator 805 can have an opening 888 configured to draw from 801 and/or 802 and provide liquid to the exit port 807.

In certain designs, the first portion 601 can include a first scrubbing member 640 coupled to an interior surface 621 of the first portion 601. The first scrubbing member 640 can be removably coupled to a holder 650, which may include a combination of mechanisms, including for example, slots and a retaining member (e.g., a strap) configured to engage the slots and the first scrubbing member 640. The holder 650 may be fixedly attached to the first portion 601, and more particularly, the interior surface 621 of the first portion 601. The first scrubbing member 640 can be removably attached to the holder 650, such that it may be removed by a user. The first scrubbing member 640 can be removable attached to the holder 650 via a mechanism selected from the group consisting of Velcro, adhesive, fastener, and a combination thereof.

The first scrubbing member 640 can include a sponge, a composite sponge having a first portion of high density and a second portion having less density (i.e., greater porosity as compared to the first portion, an abrasive material, steel wool, bristles, and a combination thereof. The portable washer housing assembly 600 can include additional scrubbing members, including for example, a second scrubbing member 641 and third scrubbing member that can include any of the features as the first scrubbing member 640. Moreover, as illustrated, in particular instances, the second scrubbing member 641 can be configured to engage a surface of the first scrubbing member 640 in the washer chamber 610 when the portable washer housing assembly 600 is in a closed position.

The first portion 601 may include a shaping surface. The shaping surface can include a forming member configured to shape a portion of a user's recreational disc. Some examples of suitable forming members can include a cutting member (e.g., a knife edge or razor), an abrading member (e.g, a coated abrasive article, a honing stone, etc.), or a combination thereof. The shaping surface can be present at an exterior surface 620 of the first portion 601.

Moreover, the first portion 601 can have an ergonomic design. Such a design may include a gripping region at an external surface 620 of the first portion 601, which can include an arrangement of protrusions and/or grooves to facilitate an effective grip by a user.

The second portion 602 can include any of the features described herein as part of the first portion 601, including but not limited to, a reservoir, a bladder, a fill port, an exit port, a drain, an actuator, a scrubbing member, a holder, a shaping surface, an ergonomic design, and a combination thereof. In one particular instance, the second portion 602 can include a second scrubbing member 641 coupled to an interior surface 622 of the second portion 602. The second scrubbing member 641 can be removably coupled to a holder 651, wherein the holder 651 can be fixedly attached to the second portion 602. According to one embodiment, the second scrubbing member 641 can be removably attached to the holder 651, which may include a mechanism, such as Velcro, adhesive, fastener, and a combination thereof.

In at least one embodiment, the second scrubbing member 641 can be different than the first scrubbing member 640 by at least one manner selected from the group consisting of composition, dimension, orientation, and a combination thereof.

In the foregoing, reference to specific embodiments and the connections of certain components is illustrative. It will be appreciated that reference to components as being coupled or connected is intended to disclose either direct connection between said components or indirect connection through one or more intervening components as will be appreciated to carry out the methods as discussed herein. The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description. The description of embodiments in combination with the figures is provided to assist in understanding the teachings disclosed herein and should not be interpreted as a limitation on the scope or applicability of the teachings. Other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

The Abstract of the Disclosure is provided to comply with the law and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

What is claimed is:

1. A disc golf disc washer comprising:
a washer assembly comprising:
a reservoir configured to contain and liquid; and
a washing region in fluid communication with the reservoir, the washing region having an opening sized for acceptance of a recreational throwing disc, wherein the washer assembly comprises a drain extending to the ground.

2. The disc golf disc washer of claim 1, wherein the washer assembly is mounted to the ground, wherein the washer assembly comprises a drain extending into the ground, wherein the drain extends to a capture reservoir, wherein the drain extends between the reservoir and the ground, wherein the drain extends between the washing region and the ground.

3. The disc golf disc washer of claim 1, wherein the washer assembly is portable.

4. The disc golf disc washer of claim 1, further comprising a dispenser connected to the reservoir, wherein the dispenser is configured to control fluid flow from the reservoir to the washing region.

5. The disc golf disc washer of claim 1, further comprising a drain connected to the reservoir, wherein the drain comprises a valve.

6. The disc golf disc washer of claim 1, further comprising a drain connected to the washing region, wherein the drain comprises a valve.

7. The disc golf disc washer of claim 1, wherein the washing region comprises first and second scrubbing members, wherein the first and second scrubbing members are oriented relative to each other to form a slot, and wherein the slot is accessible from the opening in the washing region.

8. The disc golf disc washer of claim 1, wherein the washing region comprises a first scrubbing member coupled to a holder.

9. The disc golf disc washer of claim 1, wherein the washing region comprises a first scrubbing member and a second scrubbing member, wherein the first scrubbing member has a different scrubbing characteristic than the second scrubbing member, wherein scrubbing characteristics include bristle count, bristle type, bristle arrangement, bristle length, composition, fiber arrangement, abrasive material type, and a combination thereof.

10. The disc golf disc washer of claim 1, wherein the reservoir comprises a fill access positioned within an upper region of the reservoir and comprising a valve.

11. The disc golf disc washer of claim 1, wherein the reservoir comprises a secondary basin housed internally within a volume of the reservoir and configured to contain an additive including a liquid material comprising a soap.

12. The disc golf disc washer of claim 1, wherein the washer assembly comprises a transparent material having a transparency of at least about 50% across the spectrum of visible radiation.

13. A portable disc golf disc washer comprising:
a portable washer housing assembly comprising:
a first portion comprising a first scrubbing member;
a second portion coupled to the first portion and comprising a second scrubbing member, wherein the first portion and second portion define a wash chamber; and
a reservoir contained within an interior of at least one of the first portion or the second portion.

14. The portable disc golf disc washer of claim 13, wherein the first portion comprises a hemispherical shape.

15. The portable disc golf disc washer of claim 13, wherein the first portion comprises a first scrubbing member coupled to an interior surface of the first portion, and wherein the first scrubbing member can be removable attached to the holder via a mechanism selected from the group consisting of Velcro, adhesive, fastener, and a combination thereof.

16. The portable disc golf disc washer of claim 13, wherein the second portion comprises a second scrubbing member coupled to an interior surface of the second portion, and wherein the second scrubbing member can be removable attached to the holder via a mechanism selected from the group consisting of Velcro, adhesive, fastener, and a combination thereof, wherein the second scrubbing member is different than the first scrubbing member by at least one manner selected from the group consisting of composition, dimension, orientation, and a combination thereof.

17. The portable disc golf disc washer of claim 13, wherein the first portion comprises an exit port in fluid communication with the reservoir, and wherein the exit port is in fluid communication with a surface of the scrubbing member configured to provide a fluid from the reservoir to the scrubbing member.

18. The portable disc golf disc washer of claim 13, wherein the first portion comprises an actuator movable between a first position and a second position, wherein the actuator is configured to deliver fluid to the scrubbing member.

19. The portable disc golf disc washer of claim 18, wherein the actuator is configured to create a pressure differential between the exit port and the reservoir to expel fluid from the exit port, wherein the actuator is positioned on an external surface of the first portion, wherein the actuator is configured to be user operated.

20. The portable disc golf disc washer of claim 13, wherein the first and second portion are configured to articulate relative to one another and are operably attached to each other by at least one mechanism including a slide mechanism, hinge, clip, latch, zipper, fastener, interference fit connection and a combination thereof,
